(19) United States
(12) Patent Application Publication
(10) Pub. No.: US 2012/0188796 A1
(43) Pub. Date: Jul. 26, 2012

(54) POWER COUPLING SYSTEM AND METHOD

(76) Inventor: Robert Carter Randall, Westport, MA (US)

(21) Appl. No.: 13/344,135

(22) Filed: Jan. 5, 2012

Related U.S. Application Data
(60) Provisional application No. 61/430,832, filed on Jan. 7, 2011.

(51) Int. Cl. H02M 3/335

(52) U.S. Cl. 363/21.01

(57) ABSTRACT

Systems and methods for the coupling of power through an isolation transformer. The systems generally include a primary side electrically connectable to the primary winding of an isolation transformer, a secondary side electrically connectable to the secondary winding of the isolation transformer, a primary side switch sending power pulses to the secondary side, and a secondary side feedback circuit sending a feedback signal to the primary side. A pulse detector sends power pulses to the secondary side in response to the feedback signal, while a watchdog timer sends a power pulse to the secondary side if a feedback signal is not detected within a predetermined period of time. Secondary side circuits including a slow-start circuit and a wake circuit portion manage initialization and low-load operating power requirements, respectively.

### FIELD

Embodiments of the subject matter described herein relate generally to a system and method for efficiently coupling power across an isolation transformer between a primary side source and a secondary side device.

### BACKGROUND

Complex measurement systems frequently use sensors that must be electrically isolated from each other to prevent the cross contamination of data. This is particularly true in aqueous monitoring applications, where the sensors are frequently in direct electrical contact with water. Examples of such sensors include pH sensors, contacting conductivity sensors, galvanic oxygen sensors, and the like. These sensors generally employ signal conditioning circuitry that must be powered in order to function; however, to maintain data integrity, that power pathway must be electrically isolated in addition to sensors themselves. One known solution is to use separate batteries for each sensor; however, for multi-sensor devices, replacing the batteries for each sensor would require substantial effort. Another known solution is to couple power across an isolation transformer, from a switching power supply source to the circuitry of the device. The switching power supply is configured to monitor feedback signals sent from the secondary side of the isolation transformer in order to regulate the power being sent from the primary side of the isolation transformer. That feedback signal pathway must also be electrically isolated. Known implementations of these systems use either a separate isolation transformer or an opto-isolator, i.e., a photocoupler, to transmit the feedback signal across an isolation break.

The systems described above are typically configured so that when power is first applied, the primary side automatically sends power pulses to the secondary side to power the device (and circuity generating the feedback signal). The absence of a feedback signal indicates to the primary side that the secondary side has insufficient voltage or no voltage and, unless a feedback signal is received, the primary side will continually send power pulses in order to establish the necessary secondary side voltage. Once feedback signals are received, the primary side responsively reduces its output, allowing the secondary side to maintain a desired voltage. This configuration has at least two drawbacks. First, if the secondary side is shorted, then the primary side will not receive a feedback signal (since there will be no voltage to operate the circuity generating the feedback signal), and the primary side will attempt to provide full power to the device, which is not desirable. Second, during light or no load conditions, the secondary side must generate a feedback signal to prevent unnecessary operation of the switching power supply. Generating the feedback signal of course consumes power. During heavy load conditions the power devoted to generating the feedback signal is typically insignificant in comparison to the power consumed by the device, and the power efficiency of the power system is good. However, during light or no load conditions the power consumed by generating the feedback signal may constitute a substantial fraction or majority of overall power consumption, becoming a limiting factor in the deployment life of self-powered systems.

The Applicant has determined that by reversing normal feedback logic so that the primary side increases power output only when a feedback signal is received, the primary side can be protected from overload and the system can be substantially protected from further damage due to a short. Reversing normal feedback logic also increases the power efficiency of the system during light load or no load conditions. Hence, systems and methods for implementing an isolated and demand-based power coupling scheme are disclosed.

### SUMMARY

Presented are systems and methods for obtaining isolated, demand-based power from a switching power supply while providing overload protection, improving light-load power efficiency, and optionally eliminating a separate feedback transformer or opto-isolator. The presented methods reverse normal feedback logic so that the primary side only provides operating power when a feedback signal is present. The presented systems also couple a feedback signal through the power isolation transformer, which can be advantageous if the power supply, and more particularly the isolation transformer itself, is physically divisible into multiple sections to provide a physical disconnect between the power source and the powered device. By using a single isolation transformer to couple both power and a feedback signal, fewer connections are required in comparison to existing systems.

In reversing normal feedback logic for these systems, there is a down side that must be addressed: since there will likely be no feedback signal when the system first starts, the primary side must be able to initially charge the secondary side without outputting full power into a possible short. The disclosure includes a watchdog timer on the primary side which monitors the feedback signal to see if there is a lack of feedback activity for a predetermined period of time, e.g., 5 seconds. If such a condition is detected, then the watchdog timer triggers the primary side to automatically send one power pulse, or a short burst of power pulses, through the isolation transformer at a predetermined interval (which may match the predetermined period of time, e.g., every 5 seconds, or be different from that predetermined period of time). This watchdog timer may be also be configured to trigger a shorter power pulse, or charging pulse, that conveys less power than a feedback signal-triggered power pulse. During a shorted condition, the primary side will only try to send pulses to the secondary side at the predetermined interval, and possibly only charging pulses with a shortened pulse width (e.g., as little as a few microseconds). Thus, the average initialization power sent into a short could be very low, with the short preventing the system from outputting operating power (power in excess of the pulse-per-predetermined interval of the watchdog timer-triggered pulses), whereas a typical switching power supply would go into a runaway condition, outputting maximum operating power and possibly causing further electrical failures and/or damage within the system. Additionally, if the short condition is removed, then operation according to the disclosed methods can automatically resume due to the automatic nature of the watchdog timer-triggered pulses.

The disclosure also includes a control circuit on the secondary side which reduces the number of power or charging pulses necessary to initially generate a feedback signal. Since the secondary side of a switching power supply generally employs a high value capacitor to reduce ripple voltage, it can take many pulses to charge the capacitor and power a feedback circuit. To get around this problem, the secondary side control circuit, including the feedback circuit and other optional circuits, may be configured to draw power from a low value capacitor that can be charged to a necessary voltage with fewer pulses. In this way the secondary side can initialize with less power, enhancing the demand-based aspect of the system, yet still provide proper filtering of operating power and control of ripple voltage. In addition, a disclosed slow-start circuit may actively control the charging of the high value capacitors to favor initialization of the feedback circuit.

In various embodiments, the disclosed power coupling system comprises an isolation transformer, a primary side configured to send a power pulse through the primary winding of the isolation transformer, and a secondary side configured to rectify coupled power pulses and to send a feedback signal to the primary side. The primary side includes a pulse detector configured to detect the feedback signal and to responsively trigger a power pulse. The secondary side includes a feedback circuit monitoring a control circuit voltage and configured to send the feedback signal to the primary side if the control circuit voltage is below a first predetermined voltage threshold. The primary side also includes a watchdog timer configured to trigger the primary side to send a power pulse at a predetermined interval if the pulse detector does not detect the feedback signal within a predetermined period of time.

In some embodiments, the secondary side includes a low value capacitor and a high value capacitor, where the low value capacitor powers the feedback circuit and the high value capacitor powers a secondary side device. In variants, the secondary side further includes a slow-start circuit, where the slow-start circuit is configured to charge the high value capacitor at a low rate if the control circuit voltage is below a second predetermined voltage threshold and to charge the high value capacitor at a higher rate if the control circuit voltage is above the second predetermined voltage threshold.

In some embodiments, the primary side includes a pulse width modulator configured to modulate the duty cycle of a primary side switch, with the primary side varying the pulse width of the power pulse sent by the switch based on the feedback signals detected by the pulse detector.

In some embodiments, the feedback signal is sent across the primary and secondary windings of the isolation transformer. In other embodiments, the feedback signal is sent across the primary and secondary windings of a separate isolation transformer. In still other embodiments, the feedback signal is sent across an opto-isolator. However, using a common winding pair eliminates the separate isolation transformer or opto-isolator, eliminating a potential point of failure.

In all embodiments, the demand-based triggering of power pulses through feedback signals generated by the secondary side enables an efficient use of power by limiting the power output of the primary side in the event that the primary and secondary sides are separated by an open circuit or disabled by a short circuit. In addition, the scheme enables an efficient use of power by eliminating the need for the secondary side to generate a feedback signal in order to suppress the generation of power pulses in the primary side. These features, as well as other features, functions, and advantages discussed herein, can be achieved independently in various embodiments, or may be combined in yet other embodiments, further details of which can be seen with reference to the following description and drawings.

### BRIEF DESCRIPTION OF THE DRAWINGS

The accompanying figures depict embodiments of power coupling systems and methods. A brief description of each figure is provided below. Elements identified with the same reference number in each figure are identical or functionally similar elements.

FIG. 1 is a functional diagram of an embodiment of the power coupling system and method;

FIGS. 2 and 2A-2B are a schematic circuit diagram of an embodiment of the primary side of a power coupling system and method, with FIG. 2 being a smaller scale view of the whole formed by the partial views of FIGS. 2A and 2B; and

FIGS. 3 and 3A-3B are a schematic circuit diagram of an embodiment of the secondary side of a power coupling system and method, with FIG. 3 being a smaller scale view of the whole formed by the partial views of FIGS. 3A and 3B.

### DETAILED DESCRIPTION

The following detailed description is merely illustrative in nature and is not intended to limit the embodiments of the invention, nor the application and uses of such embodiments. Furthermore, there is no intention to be bound by any expressed or implied theory presented in the preceding technical field, background, brief summary, or the following detailed description.

Remote telemetry devices, such as sondes, generally receive power from a remote power source, such as a marine battery or generator. With few exceptions, these remote power sources are self contained, since physical connections from a marine platform or vessel to an existing land-based power grid are usually impractical or impossible. These remote power sources can also be quite limited, especially when designed to be compact and/or lightweight. Batteries provide consistent power for a platform or vessel, but usually add considerable weight in proportion to their capacity. Generators or fuel cells can provide comparable power with less weight, but typically cannot scale their output efficiently during light load or no load conditions. The inefficient consumption of power resources can require a platform or vessel to use larger batteries, or to carry a larger fuel reserve, or both. Larger batteries and/or generator systems also have substantially higher costs. The efficient use of power resources by systems and methods such as those disclosed herein can increase overall system operation time, reduce required battery size, allow for smaller generator systems, and reduce the waste heat generated within remote telemetry devices as a byproduct of device operation.

### System Functional Diagram And Operation

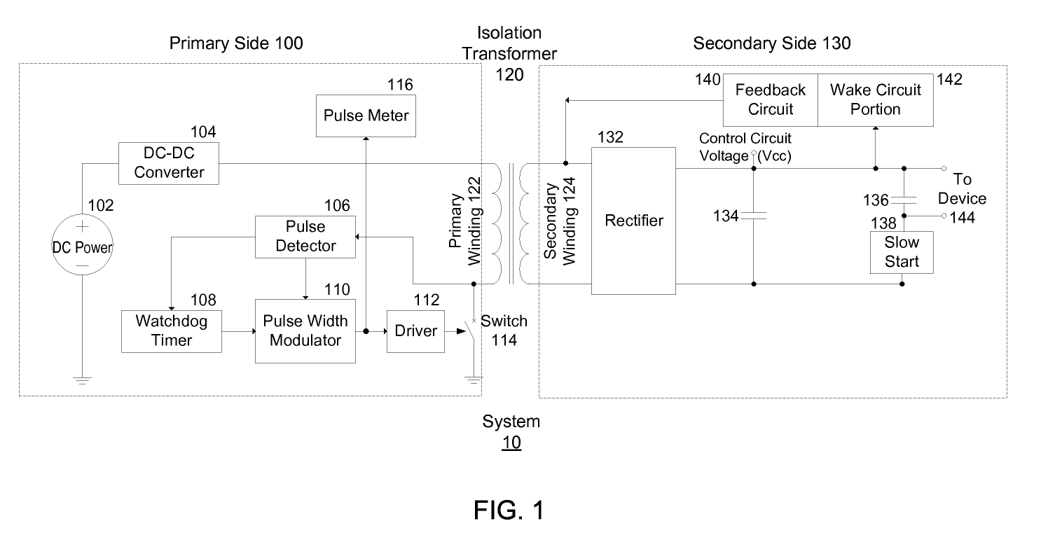

Referring now to FIG. 1, in one embodiment the power coupling system 10 comprises a primary side 100 and a secondary side 130 that are electrically isolated from each other by an isolation transformer 120. The primary side 100 comprises a DC power source 102, an optional DC-DC converter 104, a pulse detector 106, a watchdog timer 108, an optional pulse width modulator 110, an optional driver 112, and a switch 114. The secondary side 130 comprises a rectifier 132, an optional low value control circuit capacitor 134, a high value power circuit capacitor 136, an optional slow-start circuit 138, a feedback circuit 140, and an optional wake circuit portion 142. The isolation transformer comprises at least one primary winding 122 providing terminals for the primary side 100 and at least one secondary winding 124 providing terminals for the secondary side 130.

### Primary Side

The power output from a DC power source 102 may be input to an optional DC-DC converter 104 that outputs a regulated and filtered DC power output. In one embodiment, the DC power source 102 is a 12-Volt marine battery, but it can also be a 24-Volt battery, a 48-Volt battery, a fuel cell, a rectified AC source, or any other DC power source known to persons in the art. In one embodiment, DC-DC converter 104 is a switching power supply, for example a chip-based power supply circuit, but it could also be a voltage regulator such as a voltage regulating integrated circuit, a voltage or current mirror circuit, or a simple resistor network. If the DC power output from DC power source 102 is already suitable for use in the primary side 100, DC-DC converter 104 may, of course, be omitted.

The DC power output is pulsed by a switch 114 providing power pulses to the primary winding 122 of isolation transformer 120. In one embodiment, switch 114 is a type of Field Effect Transistor (FET), for example a Metal Oxide Semiconductor Field Effect Transistor (MOSFET). A MOSFET is an efficient switch, allowing large amounts of current to flow when the switch is closed, and low current leakage when the switch is open. MOSFETs also perform well at a variety of different frequencies. In other embodiments switch 114 could be a bipolar transistor or an integrated circuit with built in transistor. To pulse the primary winding 122 of isolation transformer 120, one leg of the DC power output is connected to one terminal of the primary winding 122, and switch 114 is connected between the other terminal of the primary winding 122 and a ground. When closed, switch 114 provides a low impedance path for current to flow from the DC power output, through the primary winding 122, and to ground. The current creates a magnetic field in the primary winding 122 that is coupled to the secondary winding 124 of isolation transformer 120. The amount of power coupled from the primary side 100 to the secondary side 130 of power coupling system 10 depends upon the physical dimensions, materials, and number of wire windings within isolation transformer 120 in combination with the electrical characteristics of the power pulses sent through isolation transformer 120.

To open and close switch 114, an optional driver 112 may be used to operatively bias the input to switch 114 and ensure that switch 114 opens and closes fully in response to an activation pulse. In one embodiment driver 112 is an analog push-pull amplifier, but a transistor, FET, or other circuit or integrated circuit could also be used to bias and drive activation pulses input to switch 114. For sake of simplicity, references to activation pulses being sent to switch 114 should be understood as describing pulses or signals sent to switch 114 where no driver 112 is present, or to driver 112 and thence to switch 114 where driver 112 is present.

A pulse detector 106 detects a feedback signal received from the secondary side 130 and sends activation pulses to responsively trigger switch 114 and send power pulses to the secondary side 130, i.e., to send power pulses on demand. Pulse detector 106 has the benefit that it provides a level of open circuit and short circuit protection. If pulse detector 106 does not detect a feedback signal, then only a watchdog timer 108 sends activation pulses to switch 114. Watchdog timer 108, further described below, generally sends one short pulse width activation pulse or a short series of short pulse width activation pulses, and therefore causes switch 114 to send short pulse width power pulses, or charging pulses, to the secondary side 130. In the event of an open circuit between the primary side 100 and the secondary side 130, or if there is a disabling short circuit in isolation transformer 120 or the secondary side 130, only a minimal amount of power will be sent from the primary side 110. The pulse detector 106 also advantageously minimizes the power drain on DC power source 102 if there is no device 144 to be powered on the secondary side 130 (or the secondary side 130 is physically disconnected), but will allow a device 144 to be quickly powered with a minimal amount of delay once it is operatively connected to the system 10.

To increase the amount of power provided to the secondary side 130, the secondary side 130 may send feedback signals to the primary side 100 more frequently, with the primary side 100 being responsively triggered to send power pulses more frequently. In one embodiment, feedback circuit 140 may be configured to modulate the frequency of a plurality of feedback signal pulses sent to the primary side 100 based on the control circuit voltage (Vcc), with the plurality of feedback signal pulses being sent at a low frequency if Vcc is slightly lower than the first predetermined voltage threshold, and at a higher frequency if Vcc is substantially lower than the first predetermined voltage threshold. In one variation, the frequency of the plurality of feedback signal pulses may directly modulate the frequency of feedback signal-triggered power pulses sent by the primary side 100. However in other variations, in addition to or instead of altering the frequency of the power pulses, the frequency of the plurality of feedback signal pulses may be monitored and used to alter the duration or pulse width of the power pulses to further increase current flow. Together, the desired frequency and pulse width may determine the duty cycle, or on-off ratio, of switch 114. An optional pulse width modulator 110 may modulate the duty cycle of switch 114 by modulating the pulse width of a plurality of output activation pulses based upon to the frequency of plurality of input activation pulses from pulse detector 106. As the frequency of input activation pulses increases, pulse width modulator 110 may responsively send longer output activation pulses to switch 114, which will in turn cause longer power pulses to be sent to the secondary side 130. As the frequency of input activation pulses decreases, pulse width modulator 110 may responsively send shorter output activation pulses to switch 114, which will in turn cause shorter power pulses to be sent to the secondary side 130. By modulating the pulse width of the activation pulses triggering the power pulses, the power coupling system 10 may efficiently send a large amount of power when the power demands on the secondary side 130 are high, and a small amount of power when the power demands on the secondary side 130 are low.

To initialize the circuitry on the secondary side 130, the watchdog timer 108 on the primary side 100 sends a single activation pulse or a short series of activation pulses to switch 114 or pulse width modulator 110, as the case may be. The watchdog timer 108 sends activation pulses when the pulse detector 106 has not detected a feedback signal from the secondary side 130 for a predetermined period of time, for example 5 seconds. In one embodiment, the watchdog timer 108 sends a single activation pulse at a predetermined interval, but in other embodiments the watchdog timer 108 may periodically send a short series of activation pulses at the predetermined interval. Such a series may beneficially trigger pulse width generator 110, where present, to responsively send a short series of longer power pulses in circuits requiring greater power for initialization. In some embodiments, the watchdog timer 108 sends a single activation pulse at a first predetermined interval, and a series of activation pulses at a second predetermined interval.

Watchdog timer 108 and pulse width modulator 110 may be implemented separately, but may also be combined within an integrated circuit, for example, a Field Programmable Gate Array (FPGA), logically implementing the functions of these circuits. Such an implementation may be advantageous where the primary side comprises not just one, but several switches and pulse detectors, each providing isolated power to a separate secondary side associated with an individual device—e.g., the multi-sensor aqueous monitoring devices referenced in the background of the present application. Several watchdog timers and pulse width modulators can be readily implemented on existing FPGAs. In systems configured as flyback converters, such an FPGA may include a pulse meter 116 configured to meter the activation pulses sent to switch 114 and to communicate a value based upon the metered pulses, e.g., the pulse count, a cumulative pulse width, a time averaged on-off ratio, etc. for display. Such a display could be used as a diagnostic indicator of faults within the secondary side or associated device. In other embodiments, the pulse counter 116 may be configured to communicate a value based upon the metered pulses for device control. For example, the primary side may be configured to disable the generation of output activation pulses if the communicated value exceeds a predetermined metering threshold. In systems where pulse width modulator 110 is present, the value would not be solely determined by the number of activation pulses, but also by the pulse width of each activation pulse. Such values can be readily calculated using FPGAs, although the design of functionally equivalent discrete counting circuits is within the skill of ordinary persons in the art.

### Secondary Side

The secondary winding 124 of isolation transformer 120 is connected to a rectifier 132. Rectifier 132 receives charging pulses that are coupled over the isolation transformer 120 from the primary side 100. In one embodiment, rectifier 132 is a half-wave rectifier, but it could also be full wave rectifier, a bridge rectifier, or another type of rectifier configured to rectify power/charging pulses and to output DC rectified power to a capacitor. An optional low value control circuit capacitor 134 may have a capacitance small enough to be charged by a single power pulse or a short series of power pulses. Capacitor 134 functions similarly to a battery, powering some control circuitry on the secondary side 130 including, for example feedback circuit 140, but not the device 144 itself. Alternately, a high value power circuit capacitor 136 may be charged by power pulses and directly power feedback circuit 140, however in such a case the ability to use low power charging pulses to initialize the secondary side 130 and/or to use a long predetermined interval to reduce average initialization power may be lost.

Once the low value control circuit capacitor 134 is charged, it provides power through a control circuit to feedback circuit 140 and, more specifically, to an optional wake circuit portion 142, if present. Wake circuit portion 142 monitors control circuit voltage Vcc and is configured to power the remainder of feedback circuit 140 if Vcc drops below a first predetermined voltage threshold that is related to the power necessary to operate the feedback circuit 140. When wake circuit portion 142 senses that control circuit voltage Vcc is low, it powers the rest of feedback circuit 140 in order to send a feedback signal to primary side 100. That feedback signal will be detected by pulse detector 106, which will responsively trigger a power pulse to power the secondary side 130. Wake circuit portion 142 may also be configured to provide an ultra low power mode when device 144 sends a sleep signal to the circuit. When powered off, the quiescent current of feedback circuit 140 is reduced and wake circuit portion 142, which consumes substantially less power than feedback circuit 140 as a whole, may continue to monitor Vcc. If Vcc falls below the first predetermined voltage threshold, then wake circuit portion 142 may power on feedback circuit 140 to request a power pulse. Wake circuit portion 142 may then power off other portions of feedback circuit 140 after Vcc has risen above the first predetermined voltage threshold. Since there will always be some tiny current consumption, this sleep-wake-sleep cycle must repeat occasionally to keep Vcc from dropping too low. If a device 144 determines that it needs power, it can also force wake circuit portion 142 to power on feedback circuit 140. In devices lacking a wake circuit portion 142, feedback circuit 140 monitors whether control circuit voltage Vcc is above or below the first predetermined voltage threshold, and responsively sends a feedback signal to primary side 100 when Vcc is low, rather than cycling portions of the circuit in a sleep-wake-sleep cycle as described above.

In devices including both low value control circuit capacitor 134 and high value power circuit capacitor 136, charging pulses raising the control circuit voltage Vcc would normally also charge high value power circuit capacitor 136, tending to lower Vcc. To increase the amount of power that may be provided to device 144 and reduce the output ripple voltage without depleting the power to feedback circuit 140, an optional slow-start circuit 138 may allow power circuit capacitor 136 to charge at a rate that is dependent upon the control circuit voltage Vcc. If Vcc is low, then slow-start circuit 138 may charge power circuit capacitor 136 at a low rate that maintains a minimum level of control circuit voltage Vcc. As Vcc approaches full regulating voltage, slow-start circuit 138 may charge power circuit capacitor 136 at a higher rate that at least matches an expected power demand for the device 144. Slow-start circuit 138 may switch between a simple low charge rate/high charge rate dichotomy which favors control circuit initialization over device power in the event that Vcc drops below a second predetermined voltage threshold that is related to the power necessary to operate the feedback circuit 142, or switch from a low baseline charge rate to higher charge rates that are based upon different levels of control circuit voltage Vcc (i.e., a charge rate that is a discrete or continuous function of Vcc). The first predetermined voltage threshold of wake circuit portion 142, where present, and the second predetermined voltage threshold of slow-start circuit 138, where present, may be identical to or different from each other.

### Isolation Transformer

Isolation transformer 120 may be a hardwired isolation transformer or a separable, male-female connected isolation transformer. For example, in one variation, the isolation transformer in its entirety stays physically with one of the primary and secondary sides, and a 2 pin connector connects the other of the primary and secondary sides to the isolation transformer. In another variation, the isolation transformer is physically separable into male and female pieces, with the primary winding staying physically with the primary side and the secondary winding staying physically with the secondary side. The male-female connector is configured to position the primary and secondary windings in close proximity to one another for system operation. The latter variation may be particularly advantageous in that the electrical conductors can remain insulated even when the primary side is disconnected from the secondary side; however, the reduced initialization power and shortened charging pulses permitted with the systems and methods disclosed herein will significantly reduce the corrosion of electrical conductors submerged in water, permitting the use of even simple plug-and-socket connectors between physically disconnectable primary and secondary sides.

### Practical Circuit Implementation

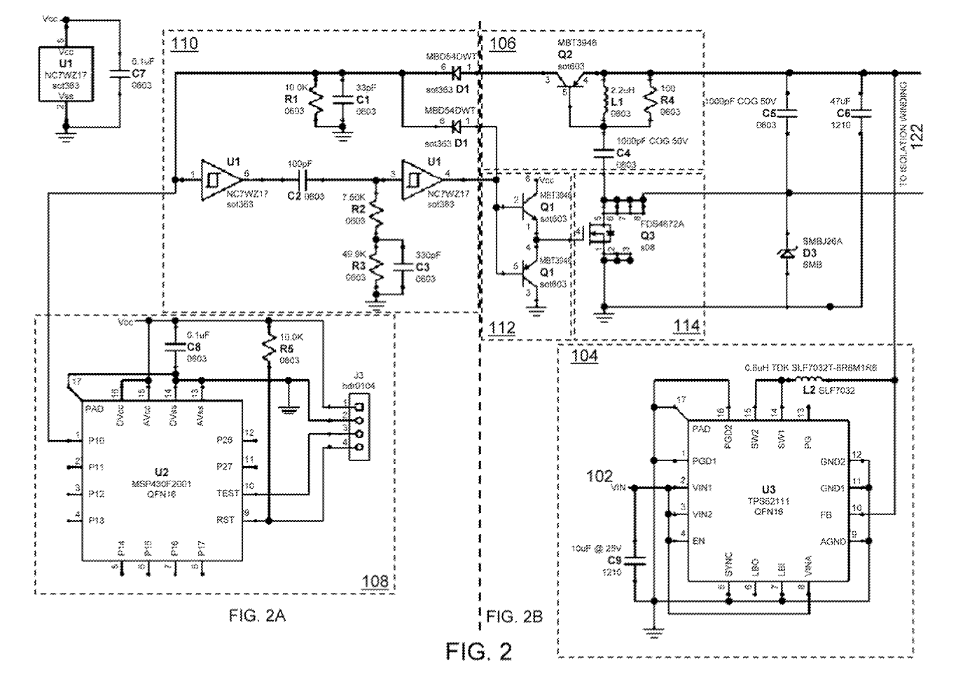

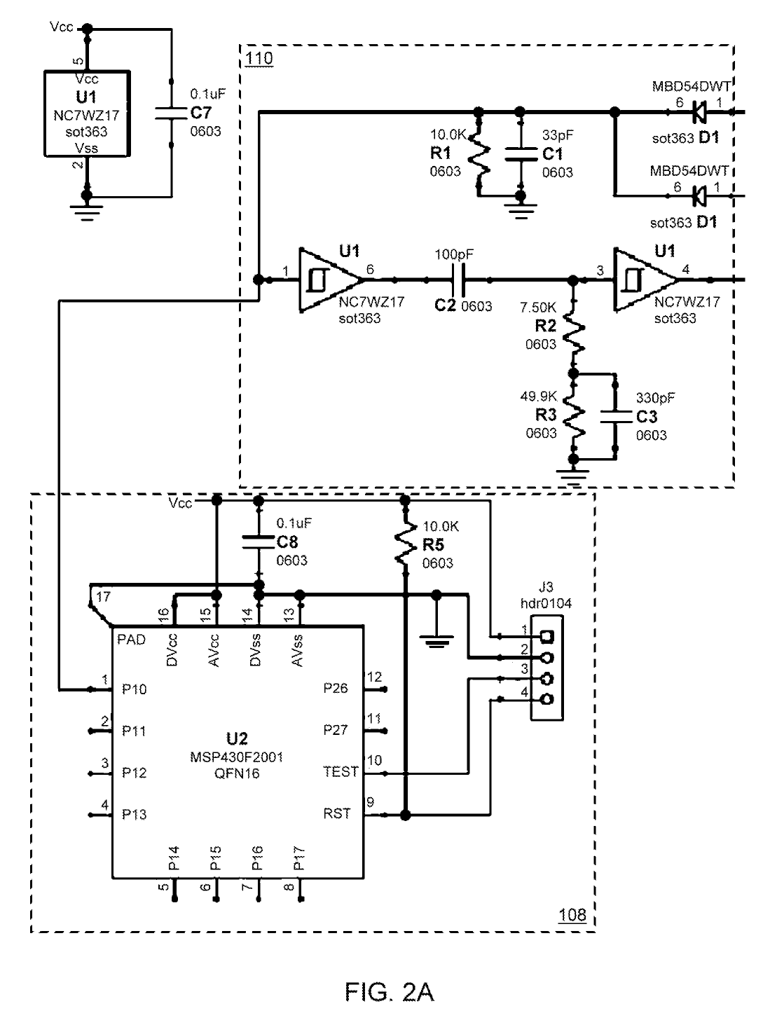

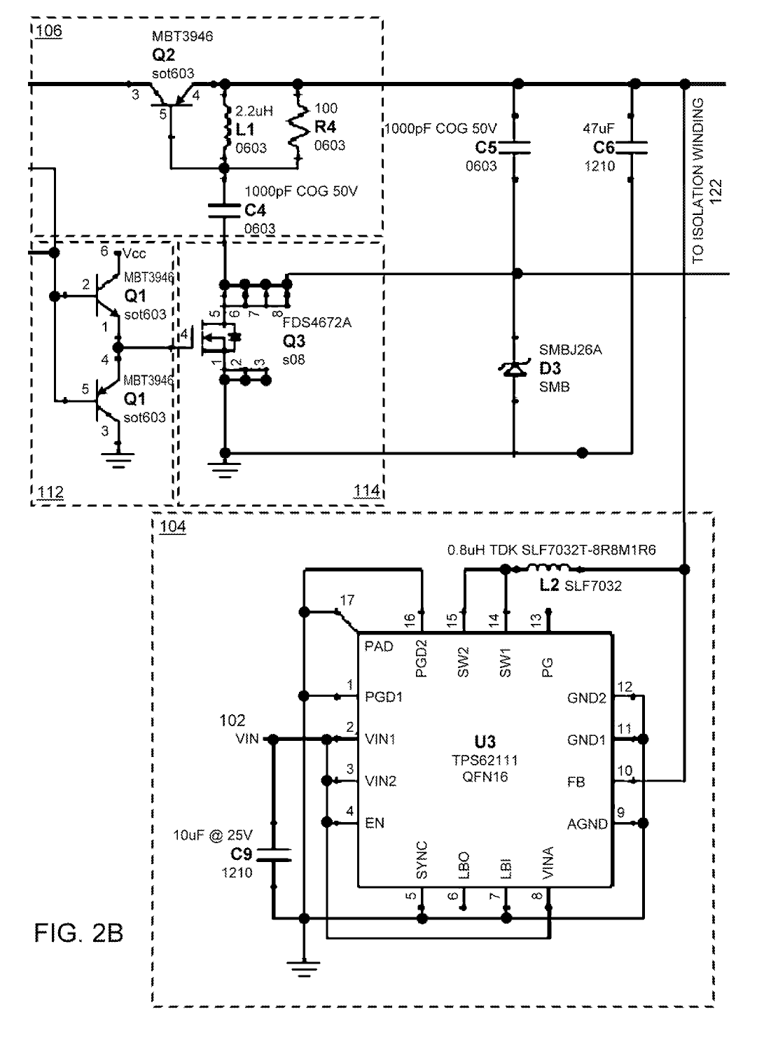

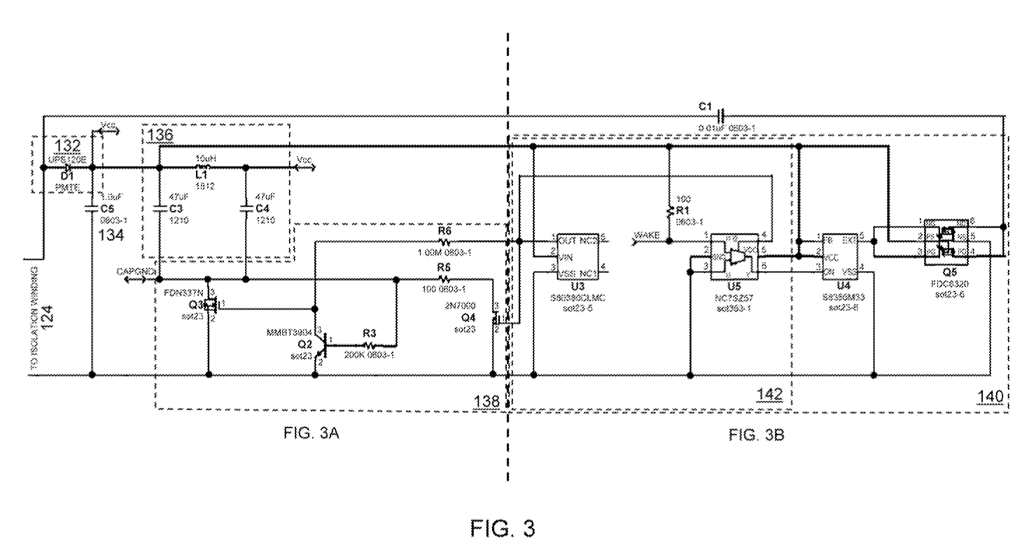

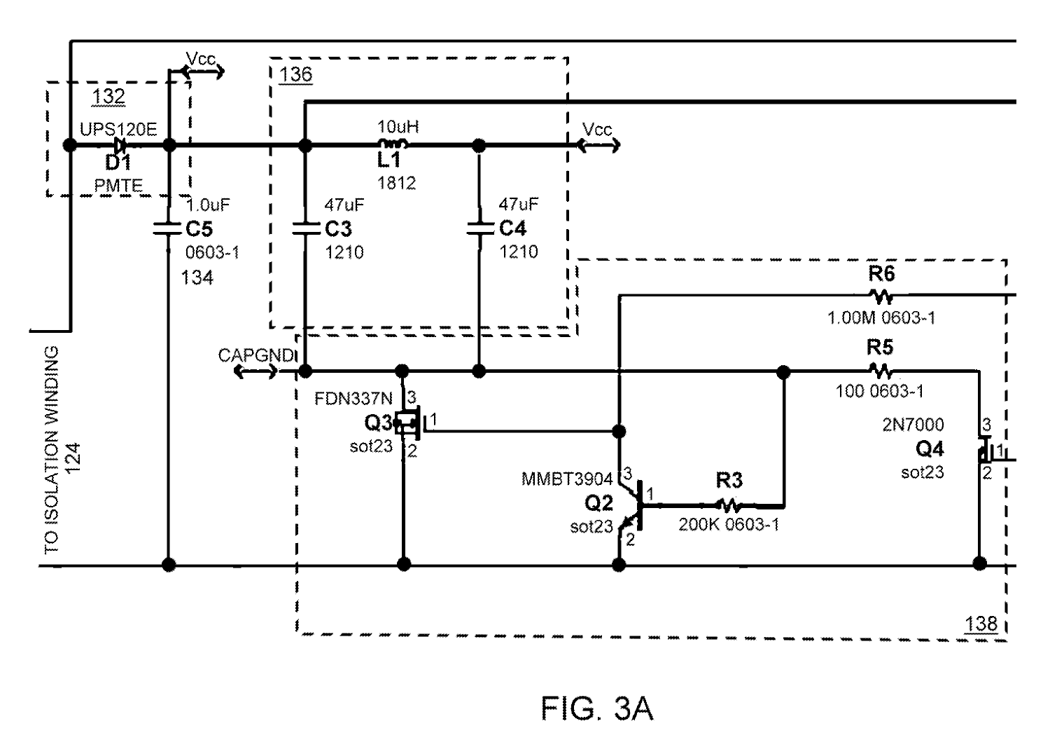

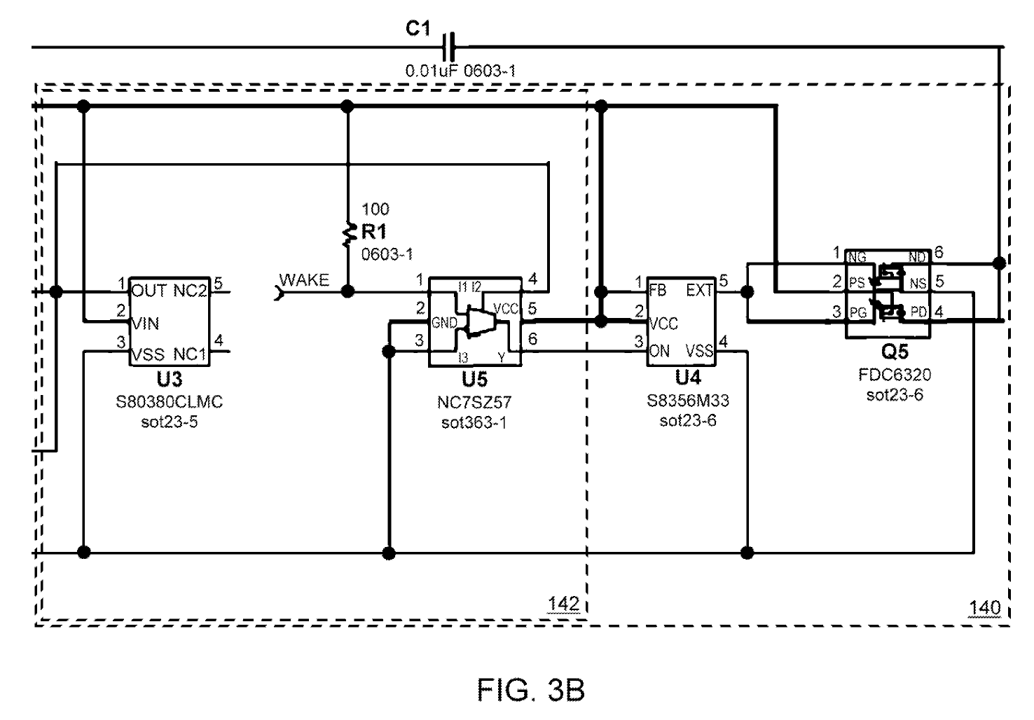

Referring now to FIGS. 2 and 3, practical circuit implementations of a primary side 100 power coupling subsystem and a secondary side 130 power coupling subsystem are presented. Referring to FIG. 2, primary side 100 power coupling subsystem includes a DC power source 102, VIN, connected to a DC-DC converter 104, chip U3. Chip U3 is a TPS62111 step-down converter that accepts voltage inputs up to as high as 17 Volts and outputs 3.3 Volts at up to 1.5 Amps. Chip U3 allows the power coupling system 10 to use power from an unregulated DC power source 102, such as a marine battery on a vessel, and output a regulated DC power output for sending power pulses across isolation transformer 120.

The 3.3 Volt regulated output from the DC-DC Converter 104 is attached to one terminal of the primary winding 122 of isolation transformer 120. The other terminal of the primary winding 122 of isolation transformer 120 is connected to switch 114, Q3. Charge from the DC-DC Converter 104 is stored in capacitor C6, which is nominally a 47 μF capacitor. The charge on C6 is discharged through isolation transformer 120 when switch 114, Q3 is closed. Driver 112 is a push-pull amplifier circuit Q1. Driver 112 ensures that the gate of switch 114, Q3, is driven to voltage levels close to rails ground and Vcc to quickly open and close switch 114.

Pulse width modulator 110 comprises two ultra-high speed dual buffers with Schmitt trigger inputs, U1, separated by capacitor C2. Capacitor C2 is nominally 100 pF. Capacitor C2 and resistors R2 and R3 determine the initial pulse width of output activation pulses sent to switch 114 through driver 112. Capacitor C3 in conjunction with resistor network R2 and R3 modulates the pulse width of output activation pulses sent to switch 114 through driver 112. Input activation pulses received by the first buffer, U1-1, causes U1-1 to go high, which is coupled across capacitor C2 to the second buffer, U1-2. Resistors R2 and R3 pull down the charge on capacitor C2, with a time constant determined by the values of C2 and R2 plus R3, causing second buffer U1-2 to go low. As the frequency of input activation pulses increases, capacitor C3 charges and remains partially charged. This decreases the discharge rate of capacitor C2 through R2 and R3, thereby modulating the output activation pulse width by lengthening the pulse width initially set by capacitor C2 as frequency increases. Diode D1 allows the pulse from second buffer U1-2 to drive the input of first buffer U1-1 so that once a pulse is initiated first buffer, U1-1 remains high until second buffer U1-2 returns to low, thereby causing the output activation pulse width to be independent of the input activation pulse width from pulse detector circuit 106. Additionally C1 charges during this time to lock out further pulses until a fixed amount of time has expired after the output activation pulse finishes. This prevents ringing in the isolation transformer from retriggering the system to cause another activation pulse. Without such a time-based lock-out, the system could break into oscillations which are undesirable. R1 and C1, along with the threshold voltage of U1, determine the length of the lock-out period.

Pulse width modulator 110 receives input activation pulses from watchdog timer 108 and pulse detector 106. Watchdog timer 108, U2, is an ultra-low-power microprocessor. Watchdog timer 108, U2, continuously monitors the activity of the feedback signal. If there is no activity for more than a predetermined period of time (e.g., 5 seconds) then watchdog timer 108 sends one or more input activation pulses to pulse width modulator 110 to initiate charging of the control circuitry on the secondary side 130 of the power coupling system 10.

Pulse detector 106 sends input activation pulses to pulse width modulator 110 in response to feedback signals received from feedback circuit 140 of the secondary side 130 (not shown in FIG. 2). Capacitor C5 and avalanche diode D3 act to clamp the output voltage, particularly in case the secondary side 130 is not present, i.e., is physically disconnected. A feedback signal received on the primary side 100 over isolation transformer 120 is amplified by transistor Q2, which transmits the amplified signal through diode D1 and into pulse width modulator 110. Resistor R1 and capacitor C1 provide a path to ground for the feedback signal. Inductor L1, resistor R4, and capacitor C4 form a high pass filter to couple the feedback signal from the isolation transformer 120 and to turn on Q2.

Referring now to FIG. 3, the secondary side 130 power coupling subsystem includes a diode D1 connected to one terminal of the secondary winding 124 of isolation transformer 120. Diode D1 functions as a half-wave rectifier 132, and charges low value control circuit capacitor 134, C5, to supply voltage Vcc to feedback circuit 140. Vcc is monitored by wake circuit portion 142, which may comprise a voltage detector, U3, and a logic gate, U5, that are configured to operate the other portions of feedback circuit 140 in the event that Vcc drops below a first predetermined threshold voltage, such as 3.0 Volts. Chip U3 is an S-80380C series ultra-low current consumption, high precision voltage detector set to the first predetermined threshold voltage. A signal line from the device 144, WAKE, may also be monitored by the wake circuit portion 142, specifically by logic gate U5, to enable the device 144 to power on or off other portions of feedback circuit 140. Powering off portions other than wake circuit portion 142 allows for an ultra low power sleep mode. U3 will force feedback circuit 140 to be powered on if Vcc drops below the first predetermined threshold voltage.

Feedback circuit 140 otherwise comprises a chip-based power supply circuit, U4, and a dual channel FET, Q5. Chip U4 is an S8356M33 CMOS step-up switching regulator, and FET Q5 is included as a buffer for the feedback signal. Feedback circuit 140 pulses through capacitor C1 above the input of diode D1 to send a feedback signal through the secondary winding 124 of isolation transformer 120. The low value control circuit capacitor 134 has sufficient capacitance to power feedback circuit 140. In the illustrated embodiment, C5 has a capacitance of 1.0 μF, however those of skill in the art will appreciate that other capacitances may be appropriate or advantageous for other embodiments.

Slow-start circuit 138 comprises Q2, Q3, Q4, R3, R5 and R6 to slowly charge C3 and C4. Q3 provides the main charging path by providing a connection to isolation transformer 120. To prevent C3 and C4 from charging too quickly, the output of wake circuit portion 142 voltage detector U3 is coupled through R6 to the gate of Q3. Q3 will only turn on if the voltage detector output is sufficiently positive. If the supply voltage is too low (e.g., less than 3.0 volts) then the voltage detector output drops to 0 volts, effectively halting further charging of C3 and C4. However it is possible for Q3 to turn on too fast, so that Vcc drops too much before the output of U3 can signal Q3 to turn off. This can occur because U3 operates with very little current, and thus comparatively slowly. To prevent this, R3 and Q2 may form a squelch circuit to disable Q3 from turning on too quickly. However, this squelch circuit can be so effective that the initial charge rate can be exceedingly slow, and therefore R5 and Q4 may provide a minimum slow charge rate because of the fixed value of R5 (in this implementation, 100 ohms). It is important to note that Q4 will only turn on if U3 indicates that the supply voltage is at least at the second predetermined threshold voltage. Once C3 and C4 are fully or almost fully charged, Q3 will turn fully on so that C3 and C4 are effectively directly connected to the power supply. When C3 and C4 are fully charged and Q3 is fully on, no more current is required to operate that part of the circuit, i.e., no bias current flows through any of the discrete components Q2, Q4, R3, R5 or R6. This maintains an ultra low current consumption, particularly in sleep mode.

The high value power circuit capacitor 136 comprises a capacitor-input filter including capacitors C3 and C4 and a filter inductor L1. Capacitors C3 and C4 have a comparatively high capacitance with reference to low value control circuit capacitor 134. In this implementation, C3 and C4 have a capacitance of 47 μF, however those of skill in the art will appreciate that other capacitances may be appropriate or advantageous, and that the capacitances of C3 and C4 need not be identical. Those of skill in the art will also appreciate that, as introduced, power circuit capacitor 136 may be a single capacitor having a comparatively high capacitance with reference to low value control circuit capacitor 134, or another capacitive circuit having a similar capacitance characteristic, depending upon rectifier 132 and the tolerance of the device 144 for noise in its power circuit.

The embodiments of the invention shown in the drawings and described above are exemplary of numerous embodiments. It is contemplated that various other configurations of the power coupling system 10 and subsystems may be created by taking advantage of the disclosed systems and methods.

What is claimed is:

1. A power coupling system comprising:
(1) an isolation transformer having a primary winding and a secondary winding;
(2) a primary side electrically connected to the primary winding, the primary side further comprising:
(a) a switch configured to receive an activation pulse and to responsively send a power pulse through said primary winding of said isolation transformer;
(b) a pulse detector in communication with said switch, said pulse detector being configured to detect a feedback signal and to responsively send an activation pulse to said switch; and
(c) a watchdog timer in communication with said switch, said watchdog timer being configured to send an activation pulse to said switch at a predetermined interval if said pulse detector does not detect a feedback signal within a predetermined period of time; and
(3) a secondary side electrically connected to the secondary winding, the secondary side further comprising:
(a) a rectifier rectifying a coupled power pulse received through said secondary winding of said isolation transformer;
(b) a capacitor electrically connected to said rectifier, said capacitor providing power and a control circuit voltage (Vcc) within said secondary side; and
(c) a feedback circuit monitoring said control circuit voltage, said feedback circuit being configured to send at least a feedback signal pulse to said pulse detector if said control circuit voltage is below a first predetermined voltage threshold.

2. The power coupling system of claim 1, wherein said feedback circuit includes a wake circuit portion monitoring said control circuit voltage (Vcc), said wake circuit portion being configured to selectively power the remainder of said feedback circuit to generate said at least a feedback signal pulse if the control circuit voltage is below the first predetermined voltage threshold.

3. The power coupling system of claim 1, wherein the feedback signal to be detected by the pulse detector is a coupled feedback signal received through said primary winding of said isolation transformer, and said at least a feedback signal pulse is sent through said secondary winding of said isolation transformer.

4. The power coupling system of claim 1, wherein said primary side yet further comprises a pulse width modulator receiving said activation pulses as input activation pulses from said pulse detector and said watchdog timer, and said pulse width modulator is configured to modulate a pulse width of an output activation pulse based upon to a frequency of said input activation pulses, with said switch receiving said output activation pulse of said pulse width modulator.

5. The power coupling system of claim 1, wherein said feedback circuit is configured to modulate the frequency of a plurality of feedback signal pulses, and to send said plurality of feedback signal pulses (1) at a low frequency if said control circuit voltage (Vcc) is slightly lower than said first predetermined voltage threshold and (2) at a higher frequency if Vcc is substantially lower than said first predetermined voltage threshold.

6. The power coupling system of claim 1, wherein said capacitor is a low value control circuit capacitor, and said secondary side yet further comprises:
(1) a slow-start circuit monitoring said control circuit voltage (Vcc); and
(2) a high value power circuit capacitor electrically connected to said rectifier at least through said slow start circuit, said power circuit capacitor providing power to a device to be powered; and
wherein said slow-start circuit is configured to charge said power circuit capacitor at a low rate if said control circuit voltage is below a second predetermined voltage threshold, and to charge said power circuit capacitor at a higher rate if said control circuit voltage is above said second predetermined voltage threshold.

7. A power coupling subsystem comprising:
(1) a secondary side electrically connectable to a secondary winding of an isolation transformer, said secondary side further comprising:
(a) a rectifier rectifying a coupled power pulse received through said secondary winding of said isolation transformer;
(b) a capacitor electrically connected to said rectifier, said capacitor providing power and a control circuit voltage (Vcc) within said secondary side; and
(c) a feedback circuit monitoring said control circuit voltage, said feedback circuit being configured to send at least a feedback signal pulse to said pulse detector if said control circuit voltage is below a first predetermined voltage threshold.

8. The power coupling subsystem of claim 7, wherein said feedback circuit includes a wake circuit portion monitoring said control circuit voltage (Vcc), said wake circuit portion being configured to selectively power the remainder of said feedback circuit to generate said at least a feedback signal pulse if the control circuit voltage is below the first predetermined voltage threshold.

9. The power coupling subsystem of claim 7, wherein said at least a feedback signal pulse is sent through said secondary winding of said isolation transformer.

10. The power coupling system of claim 7, wherein said feedback circuit is configured to modulate the frequency of a plurality of feedback signal pulses, and to send said plurality of feedback signal pulses (1) at a low frequency if said control circuit voltage (Vcc) is slightly lower than said first predetermined voltage threshold and (2) at a higher frequency if Vcc is substantially lower than said first predetermined voltage threshold.

11. The power coupling subsystem of claim 7, wherein said capacitor is a low value control circuit capacitor, and said secondary side yet further comprises:
(1) a slow-start circuit monitoring said control circuit voltage (Vcc); and
(2) a high value power circuit capacitor electrically connected to said rectifier at least through said slow start circuit, said power circuit capacitor providing power to a device to be powered; and
wherein said slow-start circuit is configured to charge said power circuit capacitor at a low rate if said control circuit voltage is below a second predetermined voltage threshold, and to charge said power circuit capacitor at a higher rate if said control circuit voltage is above said second predetermined voltage threshold.

12. A power coupling subsystem comprising:
(1) a primary side electrically connectable to a primary winding of an isolation transformer, said primary side further comprising:
(a) a switch configured to receive an activation pulse and to responsively send a power pulse through said primary winding of said isolation transformer;
(b) a pulse detector in communication with said switch, said pulse detector being configured to detect a feedback signal and to responsively send an activation pulse to said switch; and
(c) a watchdog timer in communication with said switch, said watchdog timer being configured to send an activation pulse to said switch at a predetermined interval if said pulse detector does not detect a feedback signal within a predetermined period of time.

13. The power coupling system of claim 12, wherein the feedback signal to be detected by the pulse detector is a coupled feedback signal received through said primary winding of said isolation transformer, and said pulse detector is configured to monitor said primary winding of said isolation transformer.

14. The power coupling system of claim 12, wherein said primary side yet further comprises a pulse width modulator receiving said activation pulses as input activation pulses from said pulse detector and said watchdog timer, and said pulse width modulator is configured to modulate a pulse width of an output activation pulse based upon a frequency of said input activation pulses, with said switch receiving said output activation pulse of said pulse width modulator.

15. The power coupling system of claim 12, wherein the primary side yet further comprises a pulse meter configured to meter the activation pulses sent to said switch and to communicate a value based upon the metered activation pulses.

16. A method of coupling power across an isolation transformer, the method comprising the steps of:
(1) sending a power pulse from a first circuit electrically connected to a primary winding of said isolation transformer, through said primary winding, to produce an inductively coupled power pulse in a secondary winding of said isolation transformer;
(2) rectifying, within a second circuit electrically connected to said secondary winding, said inductively coupled power pulse to produce a DC rectified voltage;
(3) charging a capacitor with said DC rectified voltage;
(4) powering a feedback circuit with said capacitor;
(5) operating said feedback circuit to send at least a feedback signal pulse to said first circuit if said DC rectified voltage is below a first predetermined voltage threshold;
(6) detecting said at least a feedback signal pulse with said first circuit; and
(7) upon detection, responsively sending a power pulse from said first circuit, through said primary winding, to further power said secondary side.

17. The method of claim 16, further comprising the step of monitoring the detection of said at least a feedback signal pulse, and sending a power pulse from said first circuit, through said primary winding, at a predetermined interval if said feedback signal is not detected within a predetermined period of time.

18. The method of claim 16, further comprising the step of modulating the pulse width of said power pulse based upon the frequency of a plurality of feedback signal pulses.

19. The method of claim 16, further comprising the step of modulating the frequency of a plurality of feedback signal pulses based upon the DC rectified voltage, with the plurality of feedback signal pulses being sent at a low frequency if said DC rectified voltage is slightly lower than said first predetermined voltage threshold, and at a higher frequency if said DC rectified voltage is substantially lower than said first predetermined voltage threshold.

20. The method of claim 16, wherein the capacitor is a low value control circuit capacitor, and further comprising the step of charging a high value power circuit capacitor, the charging being performed at a low rate if said DC rectified voltage is below a second predetermined voltage threshold, and at a higher rate if said DC rectified voltage is above said second predetermined voltage threshold.
